(19) United States
(12) Patent Application Publication
(10) Pub. No.: US 2012/0043290 A1
(43) Pub. Date: Feb. 23, 2012

(54) Length Adjustable Member

(75) Inventor: Aydin Keyvanloo, Doncaster (AU)

(73) Assignees: Aydin Keyvanloo, Doncaster, VI (AU); Liang Tung, Taipei City (TW); Andreas Klaus Gesswein, Rinteln (DE)

(21) Appl. No.: 13/266,171

(22) PCT Filed: May 13, 2010
(86) PCT No.: PCT/AU2010/000566

§ 371 Date: Oct. 25, 2011

(30) Foreign Application Priority Data
May 14, 2009 (AU) 2009902167
Aug. 27, 2009 (AU) 2009904096

(51) Int. Cl. F16M 11/26

(52) U.S. Cl. 211/183

(57) ABSTRACT

A length adjustable member (10), including, an outer tubular member (12), an inner tubular member (14) slidably disposed within the outer tubular member (12), a central post (30) fixable at its base with respect to the outer tubular member and extending within the outer tubular member, the inner tubular member being slidable between the outer tubular member and the central post and an actuating means (40) having an upper end and a lower end extending from the top of the inner tubular member, the lower end associated with a releasable locking mechanism (48) and the upper end having a release mechanism (28). The central post includes longitudinally spaced slots (34) and the locking mechanism includes a hinged pawl (50) biased to engage in the slots, whereby activation of the release mechanism causes the locking mechanism to disengage the hinged pawl from a slot allowing the inner tubular member to be slid with respect to the outer tubular member and the central post.

### FIELD OF THE INVENTION

The present invention is directed to a length adjustable member and its associated mechanism. It will be appreciated that the member may be used in either a horizontal or vertical orientation. The length adjustable members find particular application as support uprights, e.g. poles and stands, for rack assemblies, being particularly, though not exclusively, suitable for merchandising display structures.

### BACKGROUND OF THE INVENTION

In retail stores, clothing and goods for sale are displayed on racks that either protrude from a wall or are freestanding and therefore include a vertical member. In the case of “mid-floor” display stands, the vertical member may have any one of a number of types of heads, such as a circular hangrail that has supporting members that fix it to the vertical member. The rack may include a single horizontal member or a plurality of, usually four, horizontal members that protrude from the top of the vertical member. A single horizontal member may extend between two vertical members.

Display racks, particularly those used for displaying clothing, are configured to a height so that the clothing garments are suspended without the bottom of the garments touching the floor and generally so that the garments are displayed at eye level. However, it is advantageous that these same display racks can be used for garments of different lengths and for other goods. It is therefore advantageous to make the vertical member adjustable.

There have been several attempts to provide an adjustable vertical member for “mid-floor” display racks. These generally include an inner tube housed within an outer tube, such that the overall length of the vertical member may be adjusted by sliding the inner tube with respect to the outer tube. The tubes may be held at the required height by providing apertures spaced down the length of the inner and outer tubes and inserting a pin through respective apertures that line up. There are a number of other systems that require additional hardware or tools to lock the vertical members at the desired height.

One way to lock the inner tube at the required height without additional tools or components is to provide a plurality of apertures that are spaced down the length of the outer tube. A retractable pin extends from the inner tube and locks into an aperture on the outer tube. To adjust the vertical member, the pin is manually pushed, using a finger, out of engagement with the aperture and the tubes are slid to the desired height and the pin is lined up and is biased to lock into another aperture. A substantial amount of force or a tool is usually required to disengage the pin.

If additional tools are required, it can be difficult for staff to quickly and easily adjust the rack. External apertures and pins make the appearance of display racks relatively industrial looking and detract from the garments and goods for sale.

It is a preferred object of the present invention to provide an improved length adjustable member that is adaptable as an upright in merchandising display structures, is visually appealing and can be adjusted without additional tools.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

Accordingly, the present invention provides, a length adjustable member, including:
an outer tubular member;
an inner tubular member slidably disposed within the outer tubular member;
a central post fixable at its base with respect to the outer tubular member and extending within the outer tubular member, the inner tubular member being slidable between the outer tubular member and the central post; and
an actuating means having an upper end and a lower end extending from the top of the inner tubular member, the lower end associated with a releasable locking mechanism and the upper end having a release mechanism;
wherein the central post includes longitudinally spaced slots and the locking mechanism includes a hinged pawl biased to engage in the slots, whereby activation of the release mechanism causes the locking mechanism to disengage the hinged pawl from a slot allowing the inner tubular member to be slid with respect to the outer tubular member and the central post.

Preferably, the tubular members have a rectangular cross-sectional shape.

The central post may be of generally rectangular cross-section. Alternatively, the central post may be formed from a flat plate of metal, which may be bent longitudinally along two lines to create a generally U-shaped cross-section, having a front central panel and two side panels.

The actuating means is preferably a push rod extending the length of the inner tubular member. The release mechanism at the upper end of the actuating means is preferably a push button arrangement actuable from the outside of the length adjustable member, as it preferably extends out the top of the inner tubular member.

The slots are preferably of a generally triangular cross-sectional shape, with a shelf portion and an angled face, cut out of the side of a solid central post. Alternatively, the slots may be apertures cut out of the front central panel of a central post with a U-shaped cross-section.

The hinged pawl may be attached to a guide that is slidable along the central post and encompasses the central post. The guide is preferably fixed to the lower end of the inner tubular member, such that as the inner tubular member is moved with respect to the outer tubular member and central post, the hinged pawl and connected guide move with it.

The hinged pawl is preferably biased by a spring to an engaged position, where a first end of the hinged pawl engages with a corresponding slot. The hinged pawl may be shaped to correspond to the shelf portion and angled face, or be shaped to have a cut-out portion to engage under an upper edge of an aperture slot.

Preferably, at a second end of the hinged pawl is a formation which is able to be engaged by the push rod. When the push button is pressed, the push rod pushes down on the cut out section causing it to pivot against the bias of the spring and disengage from the slot.

The push rod preferably includes an abutting means, such as a circlip, above a spring. When the push rod is pushed down, the abutting means preferably compresses the spring against the guide, and, when released, the spring biases the push rod upward and away from the cut out section, allowing the hinged pawl to pivot back into engagement with a corresponding slot.

Preferably, the upper end of the push rod is stabilised by a stabilising means that slides along the inside of the inner tubular member with the push rod.

Advantageously, the length adjustable member is incorporated in a merchandising display stand.

Preferably, at the upper end of the length adjustable member is a substantially horizontal arm. The push button preferably protrudes through the arm.

According to a further aspect of the invention, there is provided a mechanism for a length adjustable member having an outer tubular member and an inner tubular member slidably disposed within the outer tubular member, the mechanism including:
a central post fixable at its base with respect to the outer tubular member and capable of extending within the outer tubular member; and
an actuating means having an upper end capable of extending from the top of the inner tubular member and a lower end, the lower end associated with a releasable locking mechanism and the upper end having a release mechanism;
wherein the central post includes longitudinally spaced slots and the locking mechanism includes a hinged pawl biased to engage in the slots, whereby activation of the release mechanism causes the locking mechanism to disengage the hinged pawl from a slot allowing the inner tubular member to be slid with respect to the outer tubular member and the central post.

### BRIEF DESCRIPTION OF THE DRAWINGS

The invention will now be described, by way of example only, with reference to the accompanying drawings, in which:

FIG. 1 is a perspective view of a length adjustable member according to an embodiment of the present invention;

FIG. 2 is a perspective view of the member of FIG. 1 with the upper section exploded;

FIG. 3 is a cross-sectional side view of a member in the engaged position;

FIG. 4 is a cross-sectional side view of the member of FIG. 3 in the disengaged position;

FIG. 5 is a perspective cut-away view of the member;

FIG. 6 is a partially exploded perspective view of the member; and

FIGS. 7A to 7F are perspective views, with exploded detail of a mechanism for a length adjustable member according to a second embodiment of the present invention, with FIG. 7B showing two alternative button embodiments;

FIG. 8 is a cross-sectional front view of the mechanism of FIG. 7 with the release mechanism depressed and the hinged pawl disengaged;

FIG. 9 is a cross-sectional front view similar to FIG. 8, with the release mechanism released and the hinged pawl engaged;

FIG. 10 is a perspective view, with a tubular member shown in cross-section, of the mechanism of FIG. 7;

FIG. 11A is a cross-sectional side view of the mechanism of FIG. 7 installed in a length adjustable member;

FIG. 11B is a perspective view of the push button of FIG. 11A;

FIG. 11C is a cross-sectional side view of the base of the length adjustable member of FIG. 11A;

FIG. 11D is a cross-sectional partial side view of a length adjustable member and mechanism according to a further embodiment; and

FIG. 11E is a perspective view of a push button.

### DETAILED DESCRIPTION OF THE EMBODIMENTS

A length adjustable member 10 is illustrated as including an outer tubular member 12 and an inner tubular member 14, slidably disposed within the outer tubular member 12, such that the overall height of the length adjustable member 10 may be varied. The tubular members 12, 14 are of generally rectangular cross-section. At the top of the inner member 14 extends, relatively perpendicularly, an arm 16 for displaying articles, such as clothing from hangers. The outer tubular member 12 may be fixed to a structure or stand.

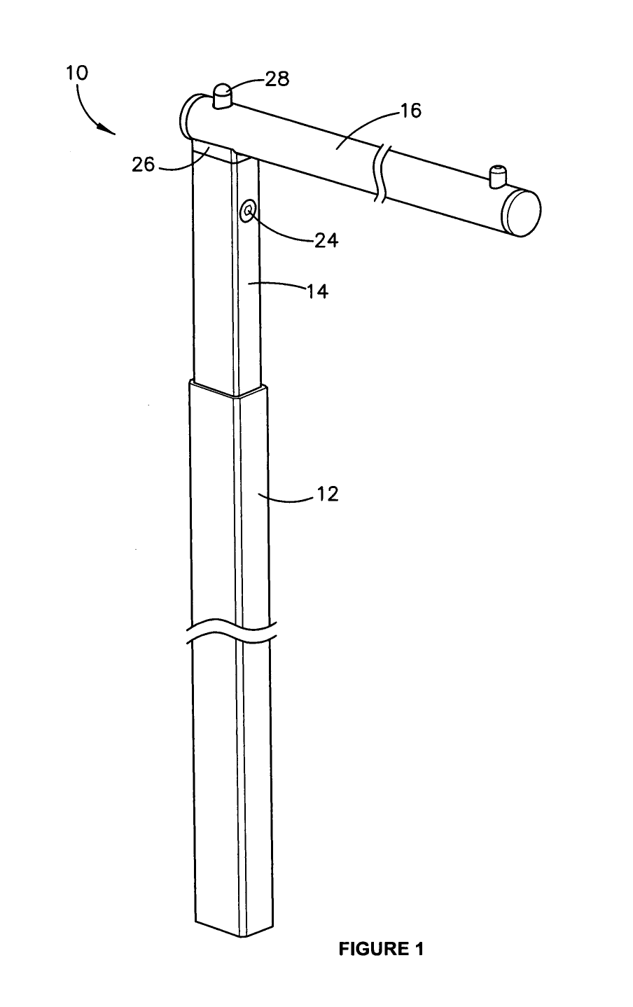

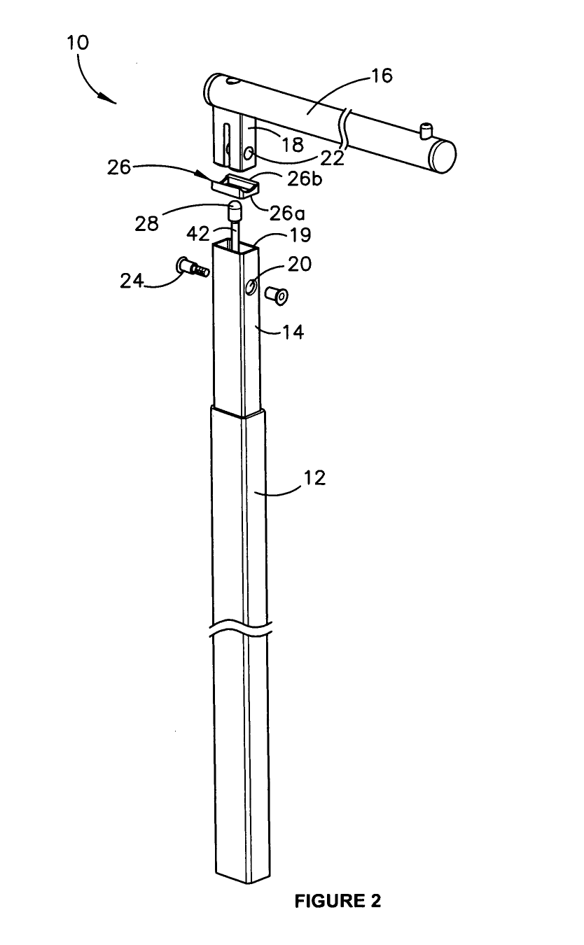

The arm 16 is removable, such that different shaped or sized arms can be used to suit the application of the member 10. As shown in FIG. 2, the arm includes a downwardly projecting attachment portion 18 of generally rectangular cross-section that slots into the open top 19 of the inner tubular member 14. The inner tubular member 14 and attachment portion 18 have corresponding holes 20, 22 through which a fastener 24 is secured. In the embodiment illustrated, the arm is of circular cross-section and the tubular members are of square cross-section, therefore a cap 26 is inserted over the attachment portion 18 to ensure a snug fit and visually appealing appearance, as seen in FIG. 1. Cap 26 has a bottom edge 26a that engages and matches the top edge of tubular member 14, and an upper profile 26b that conforms to the transverse curvature of arm 16 and therefore snuggly seats the arm. The fastener 24 is easily removed, allowing the substitution of an alternate arm, having either circular or rectangular cross-section. The arm may extend out in more than one direction from the length adjustable member 10.

At the upper end of the inner tubular member 14, projecting through a hole in the top of the arm 16, is a release mechanism in the form of a push button 28. When the button 28 is pressed it releases a locking mechanism 48, to be described below, that allows the inner tubular member 14 to be slid in and out of the outer tubular member 12 to adjust the overall height of the member 10. This allows articles, such as garments, to be displayed at different heights, depending on the need of the particular garments.

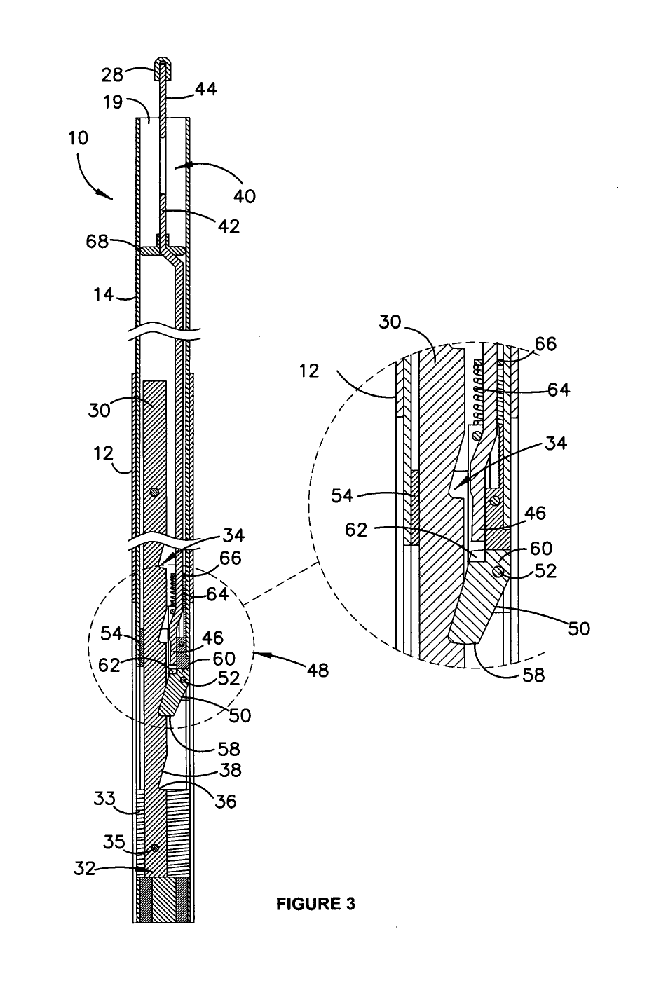

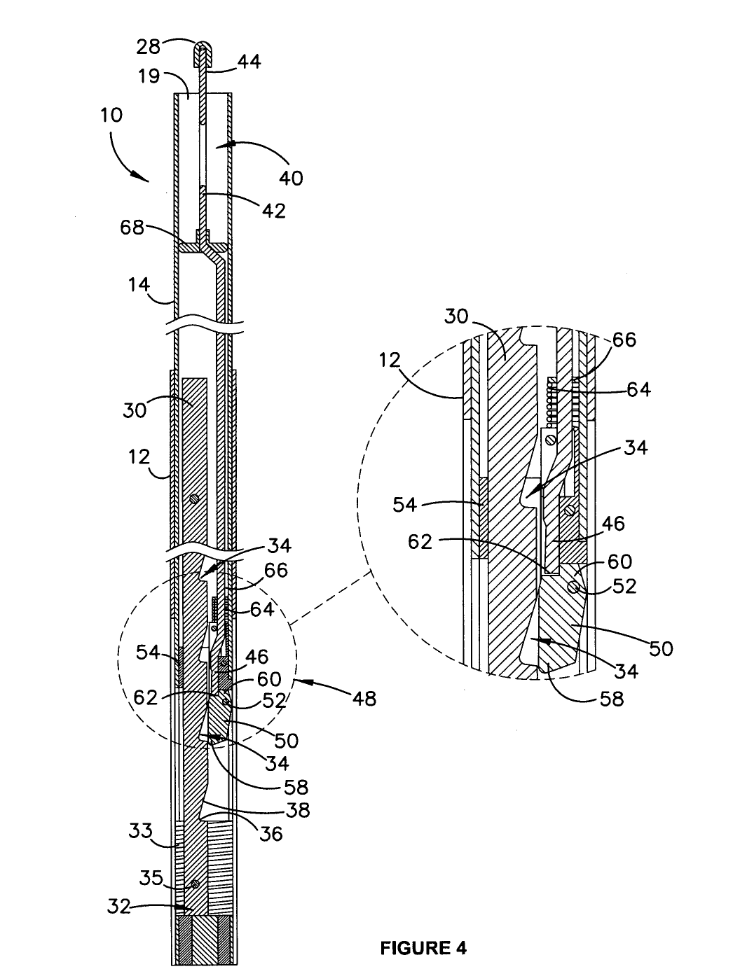

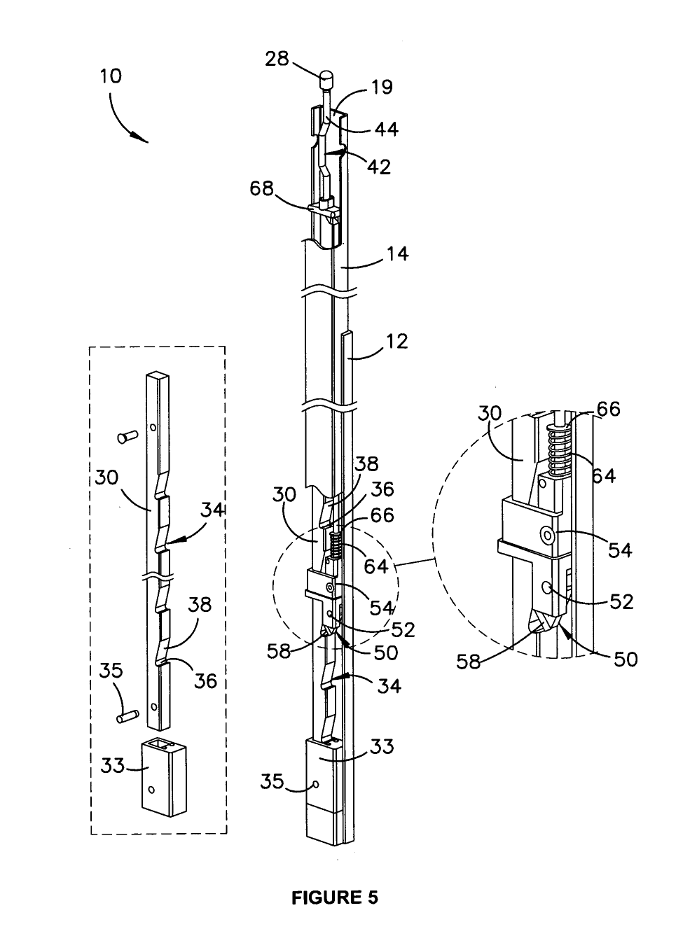

As can be seen best from FIGS. 3 and 4, inside the member 10 is a central post 30 which is fixed at its lower end 32 to the outer tubular member 12 via a base 33, secured by fastener 35. The inner tubular member 14 is slidable between the central post 30 and the outer tubular member 12. The central post includes an array of longitudinally space slots 34 on one side. As best shown in FIG. 5, the central post 30 is of generally rectangular cross-section, with the slots 34 cut out of one side. The slots 34 are of a generally triangular shape with a shelf portion 36 and an angled face 38.

An actuating means 40 includes a push rod 42 that has an upper end 44 and a lower end 46 and extends from the top to the bottom of the inner tubular member 14. The upper end 44 is attached to the push button 28. The lower end 46 is associated with a releasable locking mechanism 48.

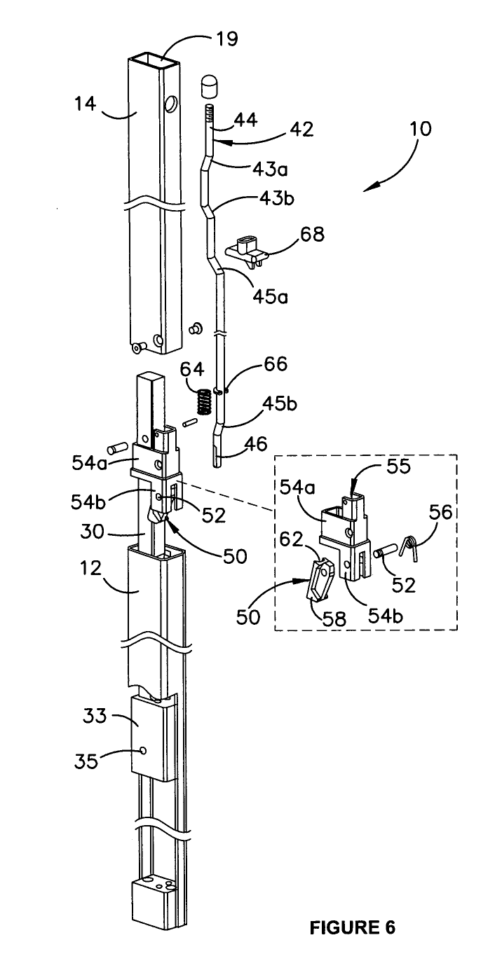

The locking mechanism 48 includes a hinged pawl 50 that is pivotable about pivot pin 52. The pawl 50 is attached to a guide 54 that is slidable along central post 30 and encompasses the post (FIG. 5). The guide 54 provides support to the central post 30 at this higher point, as it is otherwise only fixed at lower end 32. The guide 54 is fixed to the lower end of the inner tubular member 14, by the inner tubular member 14 slotting over the upper portion 54a, the lower portion 54b extends out of the bottom of inner tubular member 14 (FIG. 6). The inner tubular member 14 is moved with respect to the outer tubular member 12 and central post 30, the hinged pawl and connected guide 54 move with it. The upper portion 54a includes a channel 55 that creates room for a spring 56. The lower portion 54b has the hinged pawl 50 pivotally mounted via pin 52.

The hinged pawl 50 is biased by the spring 56, as shown in FIG. 6, to an engaged position, in which a first end 58 of the pawl engages with a corresponding slot 34. The pawl 50 is shaped to correspond to the shelf portion 36 and angled face 38 and prevents movement of the inner tubular member 14.

At a second end 60 of the hinged pawl 50 there is a formation, or cut out section, 62. When the button 28 is pressed, the push rod 42 is pushed down and its lower end 46 pushes down on the cut out section 62, causing the hinged pawl 50 to pivot against the bias of spring 56 and disengage from the slot 34. The push rod 42 includes an abutting means in the form of circlip 66, and when the push rod 42 is pushed down, the circlip 66 compresses a spring 64 against the guide 54. When the button 28 is released, the spring 64 biases the push rod 42 upward and away from the cut out section 62 of the pawl 50, allowing the pawl 50 to pivot back into engagement with a corresponding slot 34. The upper end 44 of the push rod 42 is stabilised by a brace 68 that slides along the inside of the inner tubular member 14 with the push rod 42.

As shown best in FIGS. 3, 4 and 6, the push rod 42 includes a number of bends. The uppermost bend at 43a is to enable space for the attachment portion 18 and fastener 24. The bend at 43b brings the push rod 42 back to the centre of the inner tubular member 14. The bend at 45a brings the push rod 42 beside the central post 30 and spaced from it to minimise interference. The bend at 45b then brings the lower end 46 closer to the central post 30 to line up with the cut out section 62 and make room for the spring 56.

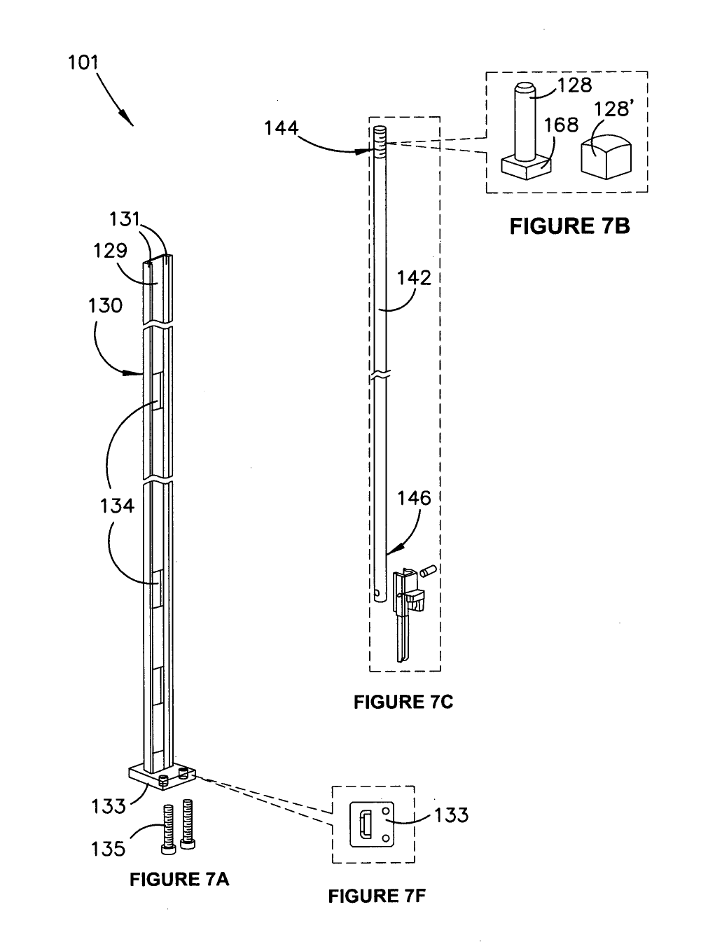

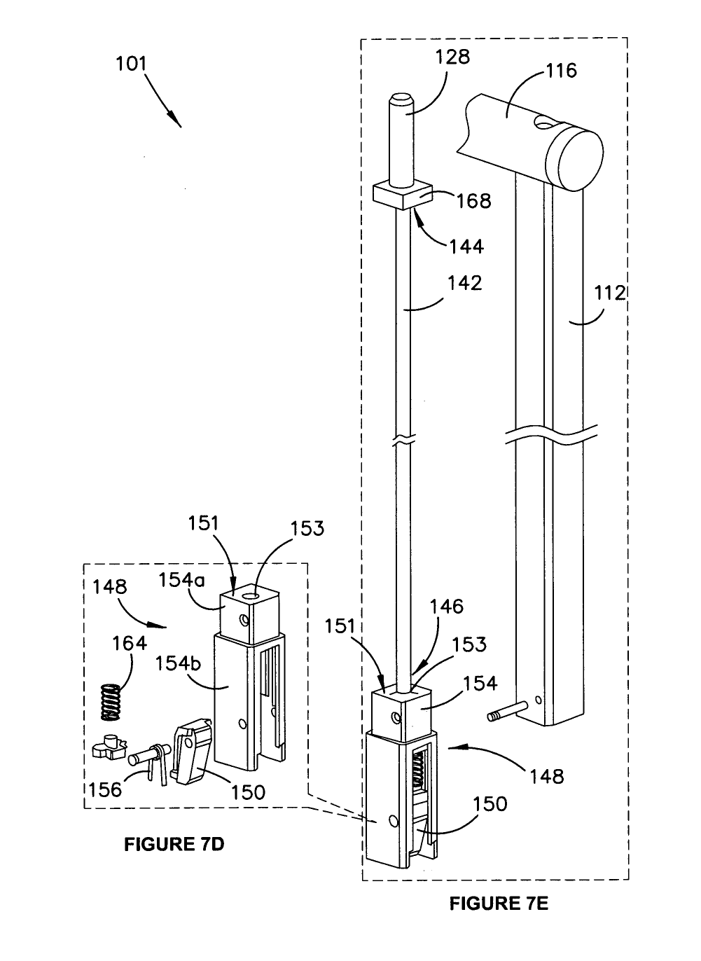

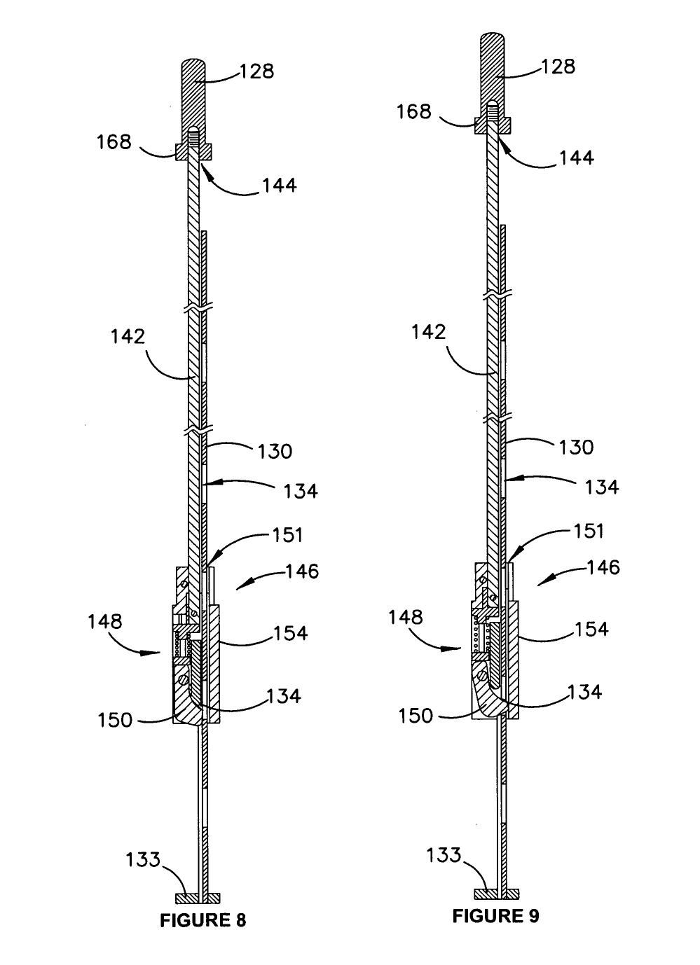

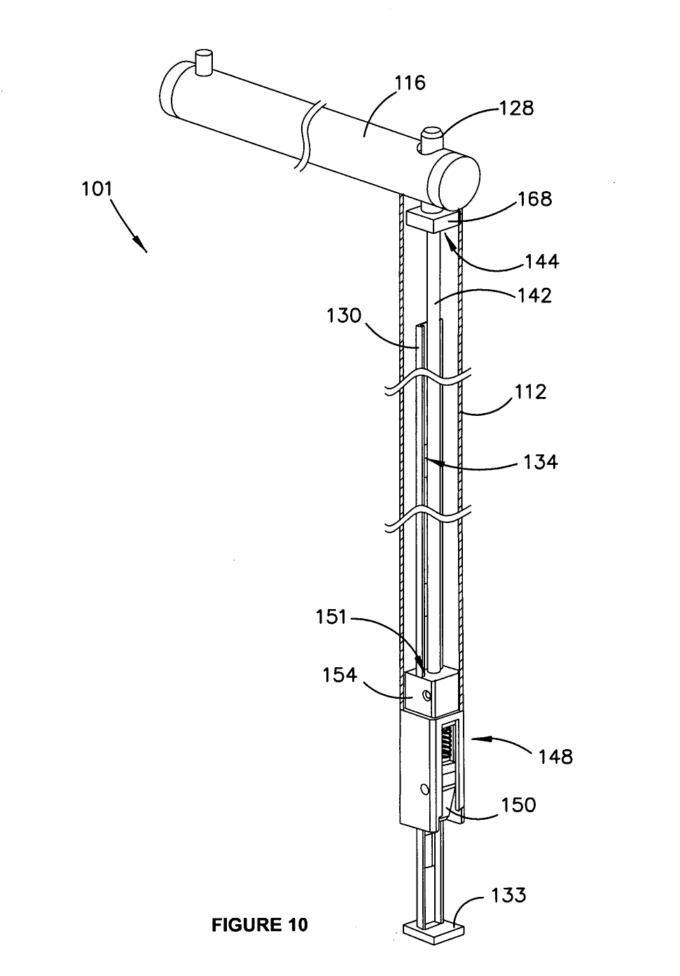

An alternative embodiment is illustrated in FIGS. 7 through 11, where like reference numerals preceded by a 1 are used to denote like parts. The embodiment shows a mechanism or kit 101 for use with a separate outer tubular member 112 and/or inner tubular member 114 to create a length adjustable member 100. The main difference between this embodiment and the embodiments shown in FIGS. 1 through 6 is that the central post 130 is made from a flat plate of metal, being bent longitudinally along two lines to create a generally U-shaped cross-section, having a front central panel 129 and two side panels 131. Slots 134 are cut into the central panel 129 for engagement by the hinged pawl 150 of the releasable locking mechanism 148. This construction reduces weight and manufacturing costs.

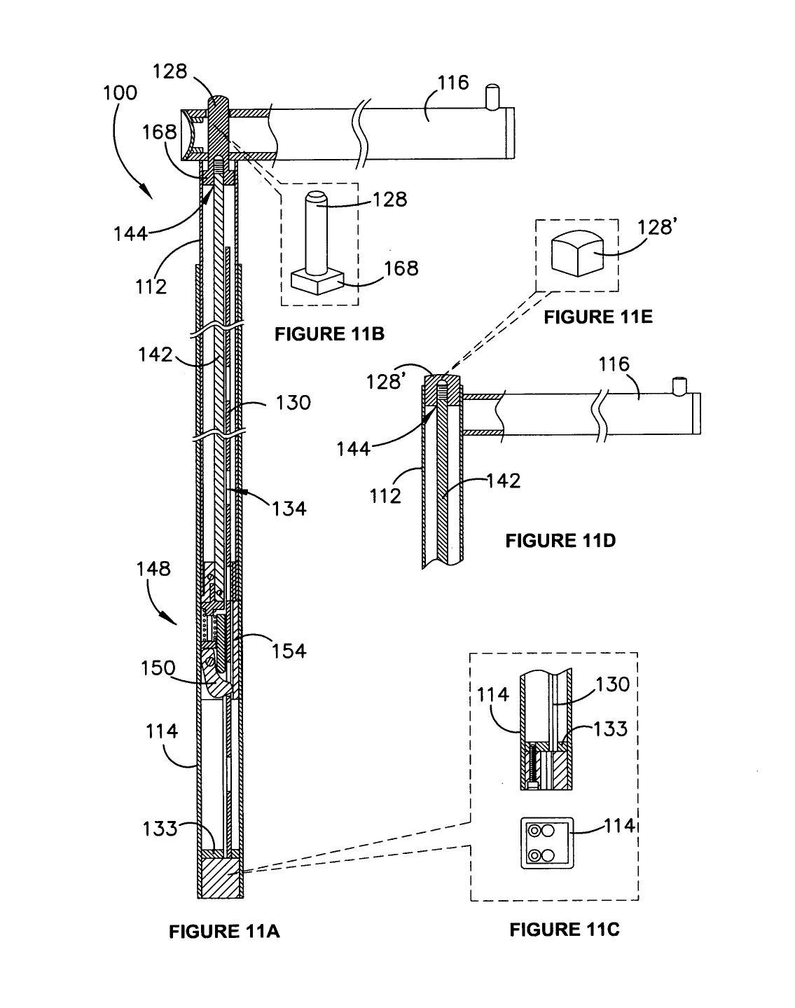

The guide 154 for the hinged pawl 150 is longer and includes a slot 151 that slides over the central post 130. The upper portion 154a includes a passage 153 into which the lower end 146 of the push rod 142 is inserted. The push rod 142 in this embodiment is straight along its length. Its upper end 144 includes a threaded section, which enables the push button 128 to be screwed on. At the bottom of the push button 128 is a brace 168 that ensures the push button and push rod are securely located within the inner tubular member 112 without lateral movement. An alternate push button 128′ is shown in FIGS. 7B, 11D and 11E and is rectangular and is able to protrude directly out of the upper end of the inner tubular member 112. In the embodiment shown in FIG. 11D, the support arm 116 is welded to the inner tubular member, instead of being removably attached, as in the other embodiments.

The length adjustable member is visually appealing, as it has a smooth outer surface, without interruption from external apertures spaced along the length of the outer tubular member, which can create a rather industrial looking product. The easy press button action of the present invention requires no extra tools and is very simple to operate, particularly in comparison to prior art systems. A press button action is more intuitive and easier to operate than more complicated prior art systems that require alternate means for adjusting. The push button mechanism is able to be used for round and square cross-sectional tubular members, as opposed to rotational locking mechanisms, which are only appropriate for circular tubular members. Another advantage over some prior art systems is that the locking mechanism relies on mechanical locking, rather than frictional locking, which is known to fail after multiple uses.

It will be understood that the invention disclosed and defined in this specification extends to all alternative combinations of two or more of the individual features mentioned or evident from the text or drawings. All of these different combinations constitute various alternative aspects of the invention.

1. A mechanism for a length adjustable member having an outer tubular member and an inner tubular member slidably disposed within the outer tubular member, the mechanism including:
a central post fixable at its base with respect to the outer tubular member and capable of extending within the outer tubular member; and
an actuating means having an upper end capable of extending from the top of the inner tubular member and a lower end, the lower end associated with a releasable locking mechanism and the upper end having a release mechanism
wherein the central post includes longitudinally spaced slots and the locking mechanism includes a hinged pawl biased to engage in the slots, whereby activation of the release mechanism causes the locking mechanism to disengage the hinged pawl from a slot allowing the inner tubular member to be slid with respect to the outer tubular member and the central post.

2. A mechanism according to claim 1, wherein the tubular members have a rectangular cross-sectional shape.

3. A mechanism according to claim 1, wherein the actuating means is a push rod extending the length of the inner tubular member, and the release mechanism at the upper end of the actuating means is a push button arrangement actuable from the outside of the length adjustable member.

4. A mechanism according to claim 1, wherein the central post is of generally rectangular cross-section.

5. A mechanism according to claim 1, wherein the central post is formed from a flat plate of metal, which is bent longitudinally along two lines to create a generally U-shaped cross-section, having a front central panel and two side panels.

6. A mechanism according to claim 5, wherein the slots are apertures cut out of the front central panel of a central post with a U-shaped cross-section.

7. A mechanism according to claim 1, wherein the hinged pawl is attached to a guide that is slidable along the central post and encompasses the central post.

8. A mechanism according to claim 7, wherein the guide is fixed to the lower end of the inner tubular member, such that as the inner tubular member is moved with respect to the outer tubular member and central post, the hinged pawl and connected guide move with it.

9. A mechanism according to claim 1, wherein the hinged pawl is biased by a spring to an engaged position, where a first end of the hinged pawl engages with a corresponding slot.

10. A mechanism according to claim 9, wherein the hinged pawl is shaped to have a cut-out portion to engage under an upper edge of each slot.

11. A mechanism according to claim 9, wherein at a second end of the hinged pawl is a formation which is able to be engaged by the push rod, whereby when the push button is pressed, the push rod pushes down on the formation causing it to pivot against the bias of said spring and disengage from the slot.

12. A mechanism according to claim 11, wherein the push rod includes an abutting means, above the spring, whereby when the push rod is pushed down, the abutting means compresses the spring against the guide, and, when released, the spring biases the push rod upward and away from the formation, allowing the hinged pawl to pivot back into engagement with a corresponding slot.

13. A mechanism according to claim 1, wherein the upper end of the push rod is stabilised by a stabilising means that slides along the inside of the inner tubular member with the push rod.

14. A length adjustable member including an outer tubular member and an inner tubular member slidably disposed within the outer tubular member and a mechanism according to claim 1.

15. A length adjustable member according to claim 23, wherein at the upper end of the length adjustable member is a substantially horizontal arm, and wherein the push button protrudes through the arm.

16. A mechanism according to claim 3, wherein the hinged pawl is attached to a guide that is slidable along the central post and encompasses the central post.

17. A mechanism according to claim 16, wherein the hinged pawl is biased by a spring to an engaged position, where a first end of the hinged pawl engages with a corresponding slot.

18. A mechanism according to claim 17, wherein at a second end of the hinged pawl is a formation which is able to be engaged by the push rod, whereby when the push button is pressed, the push rod pushes down on the formation causing it to pivot against the bias of said spring and disengage from the slot.

19. A mechanism according to claim 18, wherein the push rod includes an abutting means, above the spring, whereby when the push rod is pushed down, the abutting means compresses the spring against the guide, and, when released, the spring biases the push rod upward and away from the formation, allowing the hinged pawl to pivot back into engagement with a corresponding slot.

20. A mechanism according to claim 7, wherein the hinged pawl is biased by a spring to an engaged position, where a first end of the hinged pawl engages with a corresponding slot.

21. A mechanism according to claim 20, wherein at a second end of the hinged pawl is a formation which is able to be engaged by the push rod, whereby when the push button is pressed, the push rod pushes down on the formation causing it to pivot against the bias of said spring and disengage from the slot.

22. A mechanism according to claim 21, wherein the push rod includes an abutting means, above the spring, whereby when the push rod is pushed down, the abutting means compresses the spring against the guide, and, when released, the spring biases the push rod upward and away from the formation, allowing the hinged pawl to pivot back into engagement with a corresponding slot.

23. A length adjustable member including an outer tubular member and an inner tubular member slidably disposed within the outer tubular member and a mechanism according to claim 3.

24. A length adjustable member including an outer tubular member and an inner tubular member slidably disposed within the outer tubular member and a mechanism according to claim 7.

25. A length adjustable member including an outer tubular member and an inner tubular member slidably disposed within the outer tubular member and a mechanism according to claim 11.
